(19) United States
(12) Patent Application Publication
(10) Pub. No.: US 2007/0288373 A1
(43) Pub. Date: Dec. 13, 2007

(54) Transaction alert messages associated with financial transactions

(76) Inventor: T. Clay Wilkes, North Salt Lake, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/439,804

(22) Filed: May 24, 2006

(51) Int. Cl. G06Q 40/00

(52) U.S. Cl. 705/42; 235/380

(57) ABSTRACT

A method and system for communicating financial information to the account holder, which includes generating account information in response to the occurrence of a transaction associated with the account holder's account. The account information contains data that is descriptive of at least one aspect of the transaction. The account information is transmitted to an electronic device associated with the account holder in the form of an alert message. The account information may include fields that have been selected by the account holder. Further, the account information may be transmitted to the electronic device using a delivery method selected by the account holder.

### CROSS-REFERENCE TO RELATED APPLICATIONS

This application claims the benefit of U.S. Provisional Application No. 60/623,567, filed Oct. 29, 2004, which is incorporated herein by reference in its entirety.

### BACKGROUND OF THE INVENTION

1. The Field of the Invention

The present invention relates to information associated with financial transactions. More specifically, embodiments of the present invention relate to systems and methods of transmitting and receiving alert messages in response to transactions or other events or activities associated with a financial account or card.

2. Related Technology

In recent, years, electronic transactions have become increasingly used in consumer economic activity. A variety of financial instruments have been developed for initiating electronic transactions, including credit cards, debit cards, prepaid financial cards, and stored value financial cards, which represent examples of access methods for accessing funds that can be used in financial transactions. Some financial cards are associated with banking accounts (e.g., debit cards), while others (e.g., prepaid cards) are offered by financial institutions that pool funds from multiple cardholders and use accounting techniques to ensure that funds are properly linked to the cards.

In general, financial accounts and financial cards typically provide users with the ability to deposit, transfer, withdraw, or otherwise access money. It is important for users associated with any such financial accounts or financial cards to have convenient access to information associated with the accounts or cards, such as the individual transaction data, available funds, credit limits, etc. Financial institutions often communicate this information in monthly statements mailed directly to users. Alternatively, many financial institutions allow their account holders to access account information by visiting a website having account balances and histories, or by calling an interactive voice response (IVR) system or human customer service representatives via telephone. Information about financial accounts and cards is important because it permits users to track transactions, to be aware of current balances, and to determine whether there are indications of unauthorized access to the account. While this information is useful in connection with substantially any account or financial card, it can be especially important to users of prepaid or stored value cards. In particular, current information relating to available balances associated with prepaid or stored value cards can enable users to know whether sufficient funds are available to initiate specific transactions, or whether more funds need to be added to the cards. Conventional methods for communicating account and card information to users has not permitted cardholders, particularly those who use prepaid and stored value cards, to have convenient access to current account and card balances, etc.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment is directed to a method of communicating financial information to the account holder. The method may be practiced, for example, in a financial system that includes a financial entity that manages an account for an account holder. The method includes generating account information that is in response to the occurrence of an event associated with the account and that is descriptive of at least one aspect of the account. The account information is transmitted to an electronic device associated with the account holder. The account information may include fields that have been selected by the account holder. Further, the account information may be transmitted to the electronic device using a delivery method selected by the account holder.

Another embodiment described in more detail herein includes another, method of communicating-financial information to the account holder. The method includes collecting from the account holder one or more conditions relating to information associated with the account. The method determines if one or more of the conditions have been met, and if one or more of the conditions have been met, the method generates account information that is descriptive of at least one aspect of the account. An alert containing the account information is transmitted to an electronic device associated with the account holder using a predetermined delivery method.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a financial system used for sending financial information to one or more client devices;

FIG. 2 illustrates an exemplary alert sent to an account holder for notifying the account holder of the details of a transaction;

FIG. 3 is a flow diagram of one method of communicating financial information to the account holder; and

FIG. 4 is a flow diagram of another method of communicating financial information to the account holder.

### DETAILED DESCRIPTION OF EMBODIMENTS OF THE INVENTION

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention

The present invention relates to systems and methods for transmitting and receiving alert messages in response to transactions or other events or activities associated with a financial account or card. The invention also extends to the data structures for implementing these methods, as well as to the methods for performing transactions that generate the information.

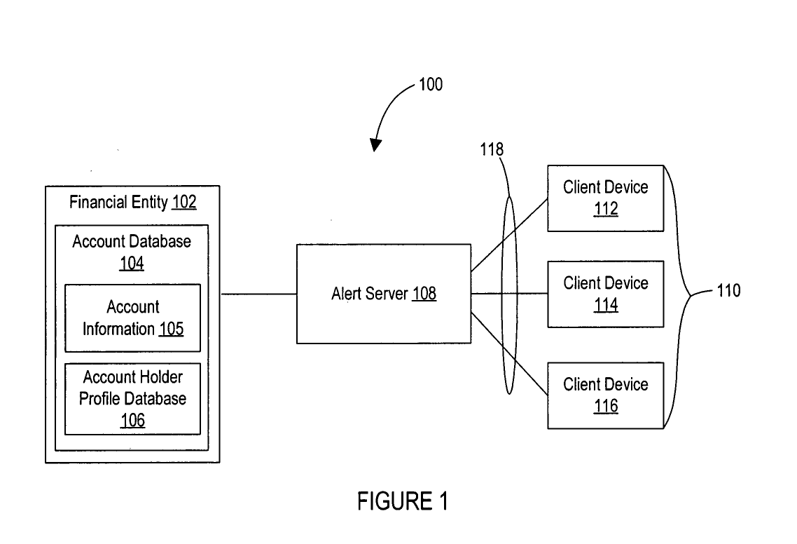

Referring now to FIG. 1, a more detailed depiction is provided of a financial system 100 for delivering alert messages to an account holder to provide the account holder with account information. As used herein, the terms “cardholder” and “account holder” refer to any person or entity who initiates a transaction using a financial card or using a financial account, regardless of whether a card has been used to access the account. As used herein, a transaction includes any type of transfer of data to or from the account, including the request for authorization, the approval of the request, the settlement of funds, as well as other types of data transfers. Transactions may be initiated in any number of ways, including the presentation of a card, the presentation of information via the telephone or internet, Radio Frequency Identification (RFID)-initiated transactions, biometrics-initiated transactions, as well as other forms of transactions that are currently in existence or that are developed in the future. Similarly as used herein, an event that is associated with an account includes all types of transactions, as well as conditions relating to the account that may be met.

The financial system 100 includes a financial entity 102, which may include any agent that provides financial services for a client account holder, such as a bank, a credit card company, a credit union, a brokerage company, and the like. The financial entity 102 stores an account database 104 containing each of the accounts held by the financial entity. According to one embodiment of the invention, an account holder initiates a transaction using a financial card by authorizing payment to the financial entity 102 or by depositing, transferring, withdrawing, or otherwise accessing funds. When the transaction is initiated or completed, the financial entity 102 associated with the transaction generates information associated with the transaction (i.e., “account information” 105). The account information 105 can include, for example, a transaction amount, a payee (e.g., merchant), a payer, a current balance, the date and time of the transaction, a deposit amount, an authorization, approval, or settlement of funds, and any other information that is conventionally used to describe an account organ account transaction.

The account information 105 may be transmitted to a server 108 that has access to a delivery method, such as e-mail, instant messaging (IM), short messaging service (SMS or “text messaging”) or multimedia messaging service (MMS) for mobile devices (e.g., wireless telephones or personal digital assistants), on-line message centers, and the like. Based on preferences selected by the account holder, the account information can be delivered to a client device 112, 114, or 116 associated with the account holder, the client devices collectively referred to as 110. The preferences of the account holder may be stored in an account holder profile database 106 by the financial entity 102, or may alternatively be stored at the server 108. The client devices 110 may include a variety of electronic devices that are capable of receiving messages, including a personal computer, a laptop computer, a cellular telephone, a personal digital assistant, a wireless handheld device, and the like.

The account information may be delivered to the appropriate client device 110 in the form of a transaction alert message that is delivered using one of the available delivery methods. An alert message is a message sent to a recipient in response to the occurrence of an event that the recipient has previously expressed interest in. Therefore, the alert messages of the present invention are sent to an account holder in response to a change or condition relevant to the account holder's account in order to notify the account holder of the change or condition. For example, the transaction alert message may notify the user of the occurrence of a transaction, and may include information associated with the transaction, such as a transaction amount, a payee (e.g., merchant), a payer, a current balance, the date and time of the transaction, and any other information that can be used to describe a transaction. In addition to including information regarding the payee, the transaction alert may include information that is customized for the payee, including advertisements, announcements, and the like.

Thus, the account holder can receive the alert messages via a client device 110 using e-mail, wireless messaging (e.g., SMS or MMS), instant messaging, on-line message centers, and the like. The alerts may be communicated to the client devices 110 via various transmission mediums 118. Exemplary transmission mediums 118 may include, by way of example, wired and wireless computer networks (LAN, WAN, Internet, WiFi, WiMax, EVDO, Edge Networks, GPRS, and the like), satellite signals, terrestrial signals, land telephone lines, cellular telephone networks, and the like.

The content of the information can be tailored according to preferences of the user. For example, in one embodiment, one user may choose to receive only the payment amount and date, while another user may choose to receive the payment amount, date and time, the payee, and other information. Furthermore, the timing of the alert messages may be customized by the user. For example, a user may specify blackout times for preventing the sending of alerts during certain time periods. The user preferences may be selected by the user via a web interface, telephone, manual submission, or the like. As described previously, the preferences of the user may be stored by the financial entity 102 in an account holder profile database 106.

In one embodiment, the account holder may submit a set of conditions that when met, trigger the sending of an alert message to the account holder to notify the account holder that one or more of the conditions have been met. For example, if an account holder wishes to be notified of the occurrence of every transaction associated with the account, one of the conditions that may be submitted by the account holder may simply be, the occurrence of a transaction. Therefore, each occurrence of a transaction satisfies the condition, thus sending an alert to the account holder. In one embodiment, the alert is sent to the account holder's client device 110 immediately following the occurrence of the transaction. For example, after an authorization request is made for a purchase using the account holder's financial instrument (e.g., a prepaid card), an alert may immediately be sent to the account holder's cellular phone to notify the account holder of the details of the authorization request.

In another embodiment, the account holder may condition the delivery of an alert on the completion of a predefined time period. For example, the account holder may specify that an alert be delivered at the close of each day to notify the account holder of the balance of the account.

In another embodiment, the conditions submitted by the account holder may be customized to enable account holders to become aware of activity that is consistent with unauthorized use of the cards or accounts by third parties. For example, one of the conditions submitted by the user may include an available balance of the account falling below a specified amount. Therefore, each time the balance falls below the amount specified by the account holder, an alert is sent to the account holder including a notification that the account balance has fallen below the specified amount. Similarly, one of the conditions submitted by the user may include a predetermined number of transactions that is exceeded within a predetermined time period. For example, the account holder may wish to receive an alert each time more than ten transactions occur within a single day.

In another example, one of the conditions submitted by the user may include a single transaction exceeding a predetermined amount, where the account holder receives an alert notifying the account holder that a purchase was made using the account holder's account that exceeded a predetermined monetary amount. Likewise, one of the conditions submitted by the account holder may include a predetermined cumulative transaction amount that is exceeded within a predetermined time period. For example, the account holder may wish to be alerted whenever more than $1,000.00 worth of purchases have been made within a two day period. Furthermore, other conditions may be established by the account holder, such that the account holder receives alerts to periodically notify the account holder of a current balance, a monthly or other periodic amount that has been spent or added to the account or card, or other information regarding activity that has occurred in the account or card.

Other examples of conditions that may be submitted by an account holder to trigger alerts may include instances where authorization was either accepted or declined in regards to a financial instrument associated with the account, notification of an expired financial instrument, a notification of a negative balance, a suspended payment, notification of a bill payment that has either cleared, been mailed, been processed, failed to process, been requested or returned, and the like. As will be appreciated by one skilled in the art, other conditions may also be submitted by the account holder for generating alerts relating to account information in addition to those described above.

While the alert messages of the invention can be useful for any account holder, in one embodiment, the present invention is employed for sending alert messages to account holders who use prepaid or stored value cards or other similar financial instruments that are susceptible to being rendered inoperative if a balance falls to zero. The alert messages may give the account holders information in a convenient form and in a timely manner that permits the information to be used to make decisions associated with the ongoing use of the account or card. In contrast to conventional techniques for communicating with account holders, the methods of the invention provide ongoing information at a frequency determined by the account holders, and as frequently as each instance of a transaction. Moreover, the information may be delivered to a wireless device or using another client device 110 selected by the account holder, so as to deliver account information in a way that can be immediately and conveniently used by the account holder.

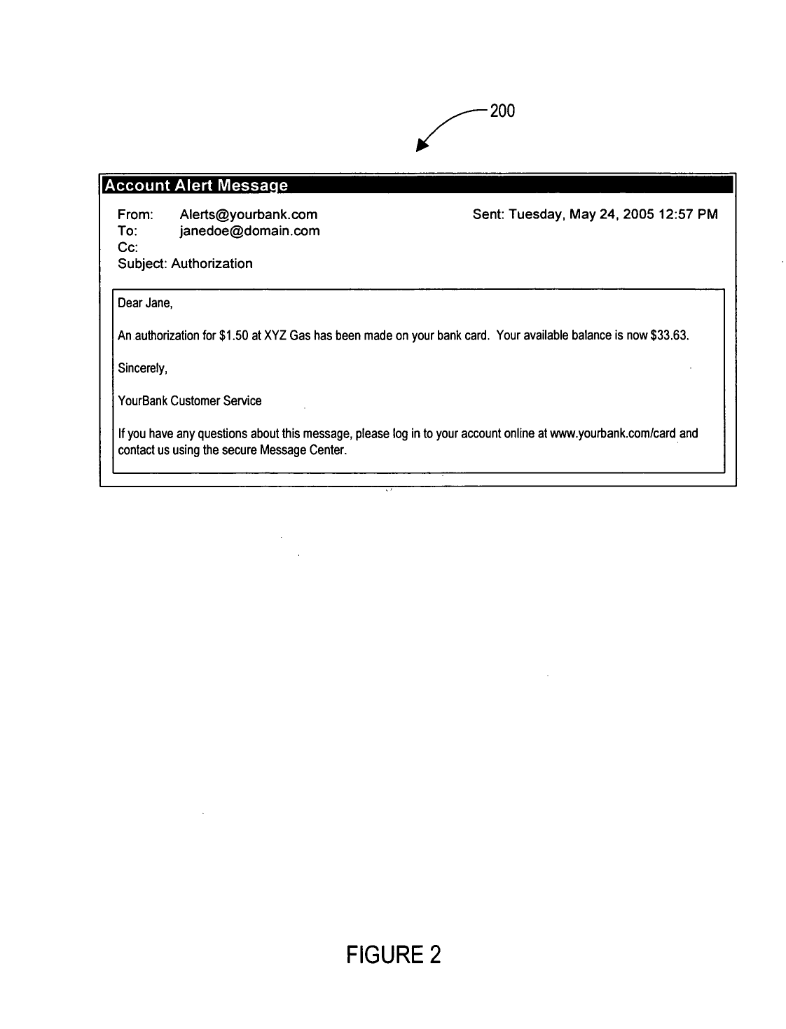

Referring now to FIG. 2, an exemplary alert message is provided describing the format and text that can be sent in an alert message, according to an embodiment of the invention. Although the alert message summarized in FIG. 2 provides useful features, the invention is not limited to this specific implementation of the methods described herein.

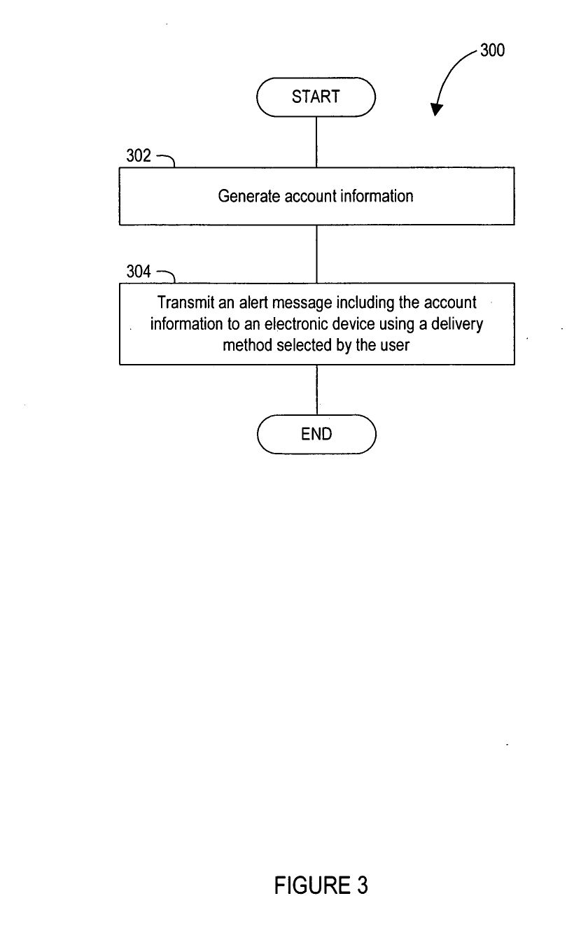

FIG. 3 illustrates one embodiment of a method 300 of communicating financial information to the account holder. The method 300 may be practiced, for example, in a financial system that includes a financial entity that manages an account for an account holder. Alternatively, the method 300 may be practiced, for example, in a communication system that interacts with the financial system. In one exemplary embodiment, the account is linked to a prepaid card or a stored value card. Following the occurrence of a transaction associated with an account holder's account, the method generates 302 account information that is descriptive of at least one aspect of the transaction.

The account information is then transmitted 304 to an electronic device associated with the account holder. The account information includes fields that have been selected by the account holder so that the information is customized for the account holder. Furthermore, the delivery method used to transmit the account information to the electronic device may be selected by the account holder. As described above, the delivery method may include SMS, MMS, IM, e-mail, and the like and combinations thereof. The electronic device employed to receive the account information may include wireless handheld devices such as cellular telephones and PDAs, personal computers, laptop computers, and the like.

In one embodiment, account information is generated 302 and transmitted 304 to the account holder each time a transaction associated with the account occurs. Therefore, the account holder receives an alert message that includes the account information with each successive transaction. In another embodiment, and referring again to FIG. 1, transmitting the account information to an electronic device 110 may also include transmitting the account information from a financial entity 102 to a server 108 that in turn transmits the account information to the electronic device 110.

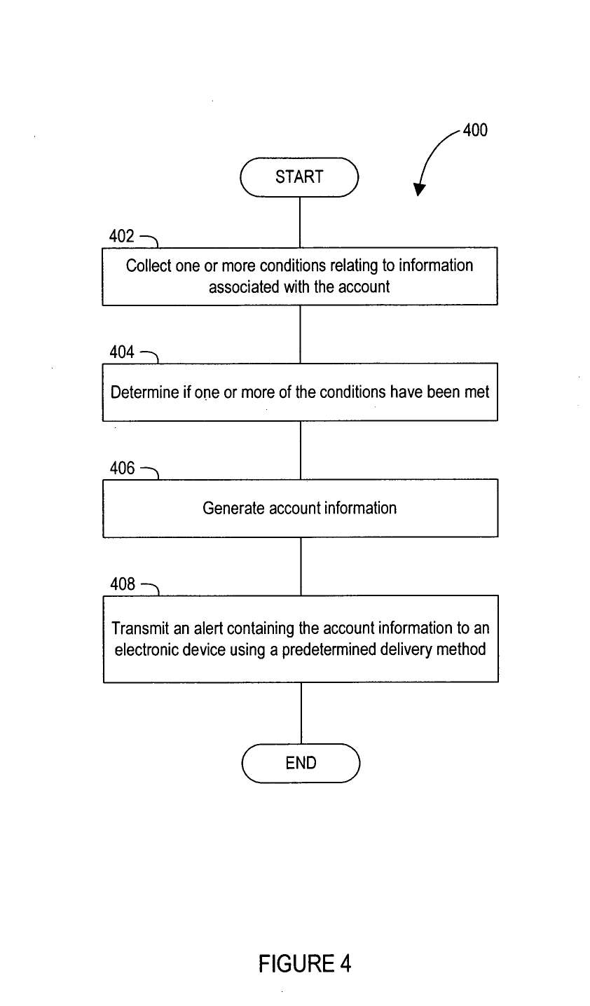

Referring now to FIG. 4, a method 400 is illustrated of communicating financial information to the account holder. The method 400 may be practiced, for example, in a system that includes a financial entity that manages an account for an account holder. The method 400 collects 402 one or more conditions relating to information associated with the account from the account holder. For example, the conditions may relate to an account balance, a transaction amount, and the like.

In response to the occurrence of a transaction associated with the account, the method 400 determines 404 if one or more of the conditions collected from the account holder have been met. If one or more of the conditions have been met, the method 400 generates 406 account information that is descriptive of the one or more conditions that have been met. The account information is then transmitted 408 to an electronic device associated with the account holder in the form of an alert message. The alert message may be delivered using a predetermined delivery method, which may be selected by the account holder.

An example of a financial system in which the alert systems and methods of the invention can be implemented is described in U.S. Provisional Patent Application Ser. No. 60/574,319, filed May 25, 2004, entitled “Financial Account Systems with Multiple Users and a its Access Methods,” which is incorporated herein by reference. Although the financial system of the referenced patent application is a suitable system in which the invention can be practiced, the alert systems and methods of the invention can also be advantageously used in substantially any other financial system that uses financial accounts or cards.

Those of skill in the art, upon learning of the invention disclosed herein, will understand techniques for implementing the delivery of the messages that are generated according to the invention. For example, alert messages that are generated and transmitted to a server associated with a wireless or cellular telephone carrier can be transmitted to wireless devices of account holders using the SMS protocol or using other conventional techniques.

The invention also extends to methods and systems for receiving preferences of the account holders regarding the information that is to be transmitted in the alert messages, and the events or activity that is to initiate the generation of the account information and the transmission of the alert messages. The invention also extends to the data structures that are used to store the preferences and the data structures associated with the account information and the alert messages. The invention further extends to methods for filtering transactions and account information using the preferences of the account holders to determine when and how to generate the alert messages. The invention also includes methods performed by the financial entities, the methods performed by telecommunication systems that enable the alert messages to be transmitted, and to any other entities that permit the alert messages to be generated and transmitted.

Embodiments of the present invention include or are incorporated in computer-readable media having computer-executable instructions or data structures stored thereon. Examples of computer-readable media include RAM, ROM, EEPROM, CD-ROM, or other optical disk storage, magnetic disk storage or other magnetic storage devices, or any other medium capable of storing instructions of data structures and capable of being accessed by a general purpose or special purpose computer. Computer-readable media also encompasses combinations of the foregoing structures. Computer-executable instructions comprise, for example, instructions and data that cause a general purpose computer, special purpose computer, or special purpose processing device to execute a certain function or group of functions. The computer-executable instructions and associated data structures represent an example of program code means for executing the steps of the invention disclosed herein.

The invention further extends to computer systems adapted for use with methods for transmitting and receiving alert messages associated with financial transactions and for otherwise communicating financial account and transaction data as described herein. Those skilled in the art will understand that the invention may be practiced in computing environments with many types of computer system configurations, including personal computers, multi-processor systems, network PCs, minicomputers, mainframe computers, and the like. The invention will be described herein in reference to a distributed computing environment, such as the Internet, where tasks are performed by remote processing devices that are linked through a communications network. In the distributed computing environment, computer-executable instructions and program modules for performing the features of the invention may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. In a financial system that includes a financial entity that manages an account for an account holder, a method for communicating financial information to the account holder, comprising:
in response to the occurrence of an event associated with the account, generating account information that is descriptive of at least one aspect of the account; and
transmitting an alert message including the account information to an electronic device associated with the account holder, wherein:
the account information includes fields that have been selected by the account holder; and
the account information is transmitted to the electronic device using a delivery method selected by the account holder.

2. The method of claim 1, wherein the electronic device is a wireless handheld device associated with the account holder.

3. The method of claim 2, wherein generating the account information and a transmitting the account information are performed each time the event associated with the account occurs, such that the account holder receives an alert message that includes the account information with each successive transaction.

4. The method of claim 1, wherein the account is linked to one of a prepaid card and a stored value card.

5. The method of claim 4, wherein:
generating the account information and transmitting the account information are performed in response to an available balance of the account falling below a specified amount; and
the account information specifies that the available balance of the account has fallen below the specified amount.

6. The method of claim 1, wherein:
transmitting the account information to an electronic device further includes transmitting the account information to a server that in turn transmits the account information to the electronic device.

7. The method of claim 1, wherein the delivery method includes one of a short messaging service, a multimedia messaging service, an electronic message, and an instant message.

8. In a communication system that interacts with a financial system that includes a financial entity that stores an account for an account holder, a method for communicating financial information to the account holder, comprising:
receiving from the financial system, account information that is descriptive of at least one aspect of the account and has been generated by the financial entity in response to the occurrence of an event associated with the account; and
transmitting an alert containing the account information to an electronic device associated with the account holder, wherein:
the account information includes fields that have been selected by the account holder; and
the account information is transmitted to the electronic device using a delivery method selected by the account holder.

9. The method of claim 8, wherein the electronic device is a wireless handheld device associated with the account holder.

10. The method of claim 8, wherein:
generating the account information and transmitting the alert are performed in response to an available balance of the account falling below a specified amount; and
the account information specifies that the available balance of the account has fallen below the specified amount.

11. The method of claim 8, wherein the delivery method includes one of a short messaging service, a multimedia messaging service, an electronic message, and an instant message.

12. In a financial system that includes a financial entity that manages an account for an account holder, a method for communicating financial information to the account holder, comprising:
collecting from the account holder one or more conditions relating to information associated with the account;
determining if one or more of the conditions have been met;
if one or more of the conditions have been met, generating account information that is descriptive of at least one aspect of the account; and
transmitting an alert containing the account information to an electronic device associated with the account holder using a predetermined delivery method.

13. The method of claim 12, wherein one of the conditions includes the occurrence of any transaction associated with the account, wherein the alert is transmitted containing the account information after the occurrence of every transaction.

14. The method of claim 12, wherein:
one of the conditions includes an available balance of the account falling below a specified amount; and
the account information specifies that the available balance of the account has fallen below the specified amount.

15. The method of claim 12, wherein:
one of the conditions includes a predetermined number of transactions being exceeded within a predetermined time period; and
the account information specifies that the predetermined number of transactions that has been exceeded.

16. The method of claim 12, wherein:
one of the conditions includes a predetermined transaction amount being exceeded on a single transaction; and
the account information specifies that the predetermined value has been exceeded.

17. The method of claim 12, wherein:
one of the conditions includes a predetermined cumulative transaction amount being exceeded within a predetermined time period; and
the account information specifies that the predetermined cumulative transaction amount has been exceeded.

18. The method of claim 12, wherein the account is linked to one of a prepaid card, a stored value card, a credit card and a debit card.

19. The method of claim 12, wherein:
transmitting the alert to an electronic device further includes transmitting the alert to a server that in turn transmits the account information to the electronic device.

20. The method of claim 12, wherein the predetermined delivery method includes one of a short messaging service, a multimedia messaging service, an electronic message, and an instant message.

21. The method of claim 12, wherein:
one of the conditions includes the completion of a predetermined time frame, wherein the alert is transmitted at the completion of the predetermined time frame.
